(19) United States
(12) Patent Application Publication
(10) Pub. No.: US 2004/0180583 A1
(43) Pub. Date: Sep. 16, 2004

(54) Mold pin for cable terminal

(75) Inventors: Masami Maruyama, Tokyo (JP); Akihiko Itoh, Tokyo (JP); Noriko Saito, Tokyo (JP)

Correspondence Address: BACON & THOMAS, PLLC, 625 SLATERS LANE, FOURTH FLOOR, ALEXANDRIA, VA, 22314

(73) Assignee: Nihon I/F Kabushiki Kaisha, Tokyo (JP)

(21) Appl. No.: 10/797,119

(22) Filed: Mar. 11, 2004

(30) Foreign Application Priority Data
Mar. 12, 2003 (JP) 2003-066671

(51) Int. Cl. H01R 4/66

(52) U.S. Cl. 439/736

(57) ABSTRACT

The constitution of a further miniaturization of a mold pin is provided which improves concentrative mounting of the mold pin and simplifies a fixing cable to the press-fitting pin. A mold pin for cable terminal forms soldered portions for fixing conductive lines protruding from the connecting end of cable at the base end of each of the press-fitting pins where the soldered portions form notch portions and at proper positions of its edge portion and solder in such a manner that the conductive lines of the cable connecting ends are inserted into the notch portions and the notch portions fills with the conductive line to an appropriate thickness, and buries the soldered portion inside the resin mold body.

### BACKGROUND OF THE INVENTION

1. Field of the Invention

The present invention relates to a mold pin for cable terminal that is inserted to through-holes provided in a printed board and electrically connects to an end of wiring with respect to a predetermined terminal of an electric circuit and, more particularly, to a mold pin for cable terminal that embodies miniaturization and integration of a mold pin.

2. Description of the Related Art

When integrated circuit (IC) is tested or the function or characteristic, etc. of IC to be mounted on a circuit is examined by connecting electrically connect through-holes for conduction provided in a printed board constituting an electric circuit by using a cable, it is indispensable to connect predetermined portions of the electric circuit to terminals for measurement using a plurality of cables.

For example, the cable has been employed to dispose a printed board or a printed board mounting IC at an object portion to be measured and connect among a through-hole for conduction as a contact of the printed board, a prober and a handler in order to perform performance test or control test of IC, or to directly connect between ICs within the tester, or to connect an electric apparatus such as television, etc. to power supply.

In the conventional work as mentioned above, a conductive line (signal line (including power-supplying line), shield line), which protrudes from the cable, is twisted and dipped for soldering. After confirming one to be target among a plurality of through-holes provided on a substrate, a dipped conductive line (signal line (including power-supplying line), shield line) is inserted in the through-hole. After that, the dipped conductive line in the state of protruding from the back face of the substrate is soldered. And unnecessarily protruded conductive line (signal line (including power-supplying line), shield line) and a soldered portion are cut. These works are repeated in the related art. This work is very difficult and should be improved since the cables could be connected in one hundred to several hundreds units.

Further, since IC comprises a plurality of pins, it is required to miniaturize a mold pin for terminal, which examines the IC, and mount mold pins as much as possible in a restricted region under the state of integration. Hence, a mold pin itself requires miniaturization.

As described above, since it is very difficult to connect a cable end to a substrate by soldering, an attempt is in progress where injection terminals on both ends of the cable are provided to inject the injection terminals into the through-holes of the board so as to electrically connect through-holes of the printed board by using the cable. Japanese Unexamined Patent Application Publication No. 64-51268 (the first page and FIG. 2) and Japanese Unexamined Utility Model Registration Publication No. 1-86179 (the first page and FIG. 2) are exemplified.

However, in these patent publications, it was a main object to obtain a sufficient contact when injecting an press-fitting pins into through-holes. Hence, as mentioned above, although it is considered that an press-fitting pin is injected into a through-hole as strong and certain as possible, like a performance test or control test, any miniaturization or integration of pin is not clearly disclosed.

### SUMMARY OF THE INVENTION

Accordingly, the present applicant has already developed a mold pin for cable terminal as shown in FIGS. 11 and 12.

Such mold pin A7 for cable terminal buried soldered portions 34 and 44 of press-fitting pins 3 and 3 and a shield line 1 and signal line 2 protruding from a cable connecting end in the mold body 5 that is composed of a synthetic resin. The mold pin A7 as constituted above enables a strong press-fit into through-holes by employing an exclusive tool, and thus certainly press-fits with respect to the terminals of through-holes, and requires no soldering of through-holes, resulting in a very simple work of connection. Further, it is effective on largely improving a fixing strength of the soldered portions 34 and 44 among shield line 1, signal line 2 and press-fitting pins 3 and 3 since the soldered portions 34 and 44 are buried after being soldered inside the mold body 5.

The soldered portions 34 and 44 of press-fitting pins 3 and 3, shield line 1, and signal line 2 are constituted so that inserting holes 53 and 63 are punched in the press-fitting pins 3 and 3 corresponding to each line and the shield line 1 and the signal line 2 are inserted into the inserting holes 53 and 63 to be soldered. The press-fitting pins 3 and 3 protrude from one side end of the mold body 5 as terminals pressed-fitted into the through-holes.

Meanwhile, the shield line 1 as well as the mold pin A7 for cable terminal shown in FIGS. 11 and 12 maintains a diameter larger than the signal line 2 even if twisted. Hence, a soldering method of inserting into the inserting hole 63 makes the soldered portion 34 itself thick and the mold body 5 becomes oversized in proportion to its thickness.

Hence, it does not satisfy miniaturization and high-integration of the mold pin.

Moreover, since the diameter of the inserting holes 53 and 63 are very small, it is very complicated to insert the shield line 1 and signal line 2 into the inserting holes 53 and 63 one by one to cut. Considering that the cables are connected in one hundred to several hundreds units as described above, it is necessary to take into more consideration of a connection structure.

The present invention was made in consideration of the problems as described above and an object of the present invention is to provide the construction for further miniaturizing a mold pin, thereby improving a concentrative mounting of a mold pin.

Another object of the present invention is to connect and fix the press-fitting pin to the cable simply.

The technical means for solving the above problems is a mold pin for cable terminal comprising press-fitting pins press-fitted into through-holes for conduction. Soldered portions for fixing conductive lines protruding from connecting ends of the cable are formed at base ends of the press-fitting pin, the soldered portions form notch portions at proper positions of edge portions and are formed in such a manner that the conductive lines of the connecting ends of the cable are inserted into the notch portions and the notch portions fills with the conductive lines to an appropriate thickness, and the soldered portions are buried inside the resin mold body.

In this structure, the conductive lines are, for example, a signal line (including power-supplying line, etc.) and a shield line.

According to the above means, the conductive lines capable of restricting thickness of the soldered portions by a portion buried inside the notch portions, and further reducing thickness of the mold body that buries the soldered portions. Further, the conductive lines buried inside the resin mold body is signal lines or a signal line and a shield line, in which at least the shield line is effective on even being fixed by each press-fitting pin in the soldered portions.

Both the signal line and shield line have a necessary diameter even if twisted. In particular, the shield line has larger diameter than the signal line. Hence, according to the above means, since at least the shield line is buried inside the notch portion to restrict thickness of the soldered portion, the mold body can be thinner thereby the mold body is miniaturized.

Further, likewise the press-fitting pin, the signal line is fixed to the press-fitting pin by soldering method of inserting it into the notch portion, mounting it to the press-fitting pin to be soldered and inserting its tip into the inserting hole formed on the tip of the press-fitting pin. Since the signal line has a diameter smaller than the shield line even if it is a twisted line, use of such constitution does not cause maximization (thickening) of a mold body.

Further, it is preferable that a notch portion of the soldered portion for fixing the shield line of cable be cut off from the edge portion in the same direction as the twisted shield line.

Here, the notch portion is formed by being cut off from the edge portion with an angle (for instance, 30° to 60°) capable of putting the shield line automatically inclined to the cable, if the shield line protruding from the connecting end of the cable is a twisted line, in a straight line from the cutting portion.

That is, the shield line in one-core coaxial cable or two-core coaxial cable, etc. is twisted with an angle with respect to the cable. And, the inclined angle depends on a kind of mold pin for cable terminal. The notch portion is cut off in the same direction as the shield line that is composed of the twisted line.

According to the above means, the shield line is soldered by inserting into the notch portion formed on the press-fitting pin with an angle with respect to the edge portion.

It is more preferable that the soldered portion for fixing a cable signal line to an press-fitting pin be formed by cutting a notch portion from the edge portion in the same direction as the twisted signal line and simultaneously, be soldered in such a manner that a signal line is inserted into the notch portion and the notch portion fills with the signal line to an appropriate thickness.

For example, if a signal line protruding from the connecting end of an one-core coaxial cable is a twisted line, it becomes coaxial-shaped with a cable, and a signal line slowly inclines as compared with a shield line in multi-core coaxial cable having more than two cores.

According to the means, a signal line as well as a shield line is put into the notch portion to be soldered in order to connect and fix to the press-fitting pin.

Further, a cable is one-core coaxial cable or multi-core coaxial cable having more than two cores in which it is more desirable if a multiple of the press-fitting pin are each in parallel provided in a supporting frame at intervals so as to be separable from a base end and an opposite side end, and the shield line and the signal line are inserted into the notch portion to be soldered in each of the press-fitting pin that is supported by the supporting frame.

The width of each notch portion is relatively larger than the diameter of shield line and signal line that are composed of a twisted line.

According to the means, the shield line and the signal line are put into the notch portion of a cantilever-shaped press-fitting pin which is linked to the supporting frame so that its one end side is separated, and the notch portion is soldered so that the notch portion fill with the conductive line to an appropriate thickness to connect and fix the shield line and the signal line to the press-fitting pin.

To put a shield line into the corresponding notch portion results in automatically inserting a signal line into the corresponding notch portion. Even if the signal line is located near such as just above the corresponding notch portion due to individual difference when putting a line, it can be with ease put into the notch portion above by using a finger.

The shield line and the signal line, each of which puts into the corresponding notch portion, do not fall out by being occluded inside of each notch portion. Hence, soldering can be made at a time after putting the shield line and signal line into all of press-fitting pin provided on a supporting frame to be separated.

Further, the shield line is set to put into the notch portion from the cutting portion and likewise the signal line from the cutting portion or the upper portion so that the shield line and signal line can not be put into the inserting hole, thereby restricting the length of projection (exposure) of the shield line and the signal line protruding from the cable connecting end to 2 to 4 mm, which is preferable to prevent change in an electric characteristic (impedance) of the cable.

### BRIEF DESCRIPTION OF THE DRAWINGS

FIG. 1 is a front view of a cable having a mold pin for cable terminal on its end according to a first embodiment of the present invention, in which some portions are omitted;

FIG. 2 is an enlarged cross-sectional view of the mold pin for cable terminal;

FIG. 3 is a cross-sectional view along the line III-III shown in FIG. 2;

FIGS. 4A to 4C are front views illustrating a fixing process for the press-fitting pin of a shield line and a signal line in that FIG. 4A illustrates state of before putting the shield line and the signal line into a notch portion, FIG. 4B illustrates state of constituting each soldered portion, and FIG. 4C illustrates state of being separated according to a cutting line;

FIG. 5 is a front cross-sectional view of the mold pin for cable terminal according to a second embodiment of the present invention;

FIG. 6 is a front cross-sectional view of the mold pin for cable terminal according to a third embodiment of the present invention;

FIG. 7 is a front cross-sectional view of the mold pin for cable terminal according to a fourth embodiment of the present invention;

FIG. 8 is a front cross-sectional view of the mold pin for cable terminal according to a fifth embodiment of the present invention;

FIG. 9 is a front cross-sectional view of the mold pin for cable terminal according to a sixth embodiment of the present invention;

FIG. 10 is a front view of the mold pin for cable terminal according to a seventh embodiment of the present invention;

FIG. 11 is an enlarged cross-sectional view of the conventional mold pin for cable terminal; and

FIG. 12 is a cross-sectional view along line XII-XII shown in FIG. 11.

### DESCRIPTION OF THE PREFERRED EMBODIMENT

Preferred embodiments of the mold pin for cable terminal according to the present invention will now be described with reference to the drawings.

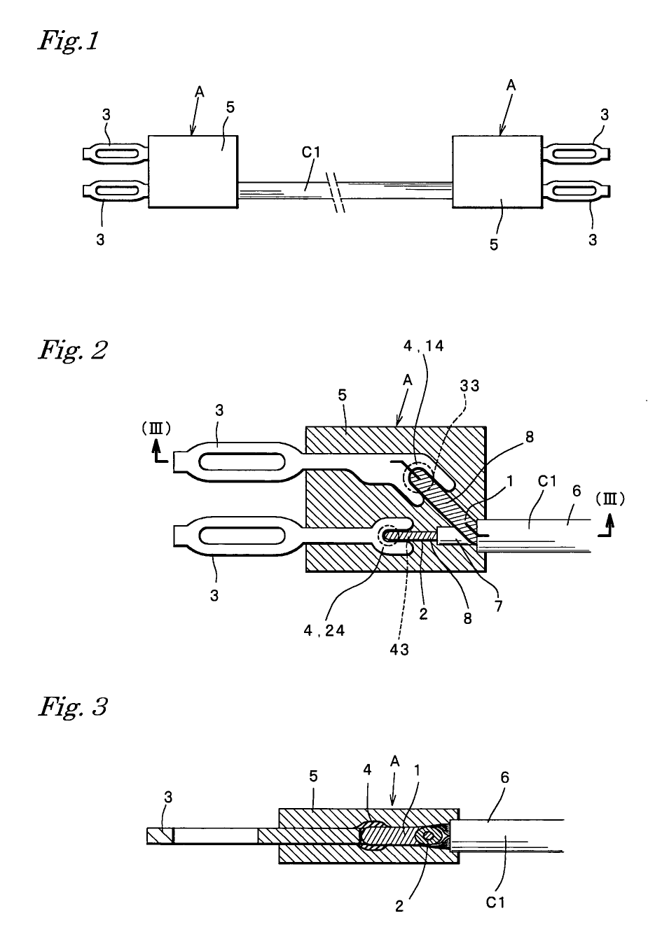

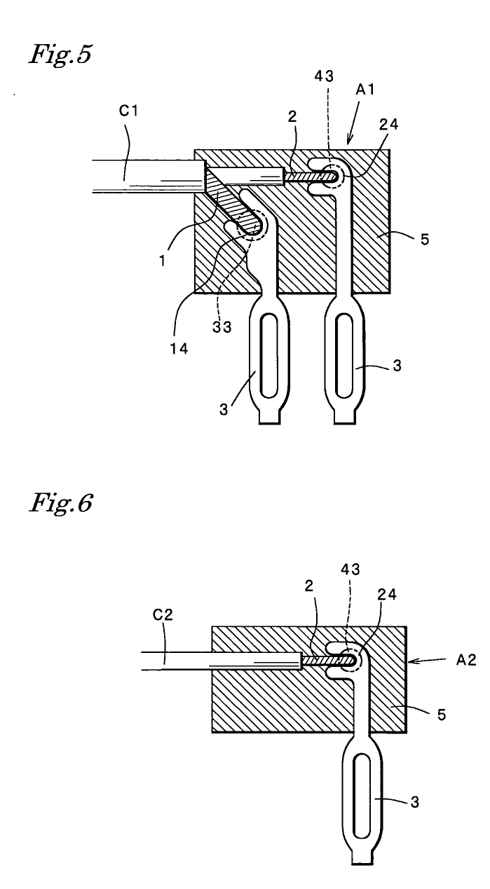

FIGS. 1 to 4A to 4C illustrate the first embodiment of a mold pin for cable terminal according to the present invention, and FIGS. 5 to 10 illustrate each the second to seventh embodiments.

Reference numeral A is referred to as the mold pin for cable terminal.

First, the first embodiment shown in FIGS. 1 to 4A to 4C is described.

As shown in FIGS. 1 to 3, the mold pin A for cable terminal fixes press-fitting pins 3 and 3 press-fitted into a through-hole for conduction (not shown) to a shield line 1 and the signal line 2 which are conductive lines protruding from a one-core coaxial cable C1 by soldered portions 4 and 4, and buries the soldered portions 4 and 4 inside the synthetic resin mold body 5 so as to increase strength of connection and fixing of the soldered portions 4 and 4.

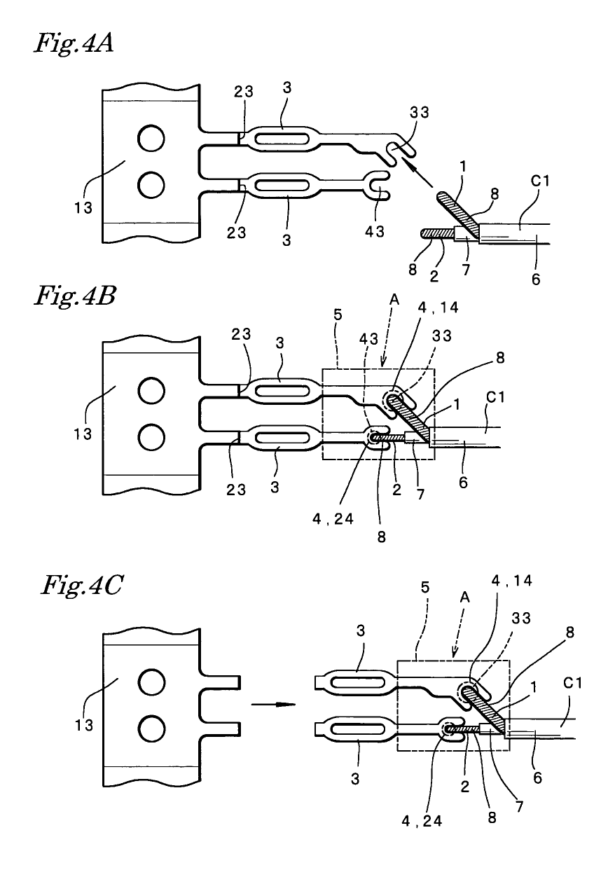

As shown in FIGS. 4A to 4C, a plurality of the press-fitting pin 3 are provided parallel to each other at a supporting frame 13 while being spaced from each other so as to be separable from the cutting line 23 at an end opposite to a base end fixed to the soldered portion 4.

Further, the press-fitting pins 3, which one is for connecting and fixing the shield line 1 and the other is for connecting and fixing the signal line 2, are provided adjacent to each other in a cantilever shape serially in the supporting frame 13.

As shown in FIG. 2 or FIGS. 4A to 4C, the press-fitting pin 3 for connecting and fixing the shield line 1 forms a notch portion 33 (hereinafter referred to as notch portion for shield line) capable of inserting the shield line 1 to be a straight line automatically inclined with respect to the cable C1, if the external film 6 is taken off to make a twisted line, in a slightly tilted manner from the edge portion at the base end.

Further, as shown in FIG. 2 or FIGS. 4A to 4C, the press-fitting pin 3 for connecting and fixing the signal line 2 is shorter than the press-fitting pin 3 on which the notch portion 33 for shield line is formed and forms a notch portion 43 (hereinafter referred to as notch portion for signal line) from the edge portion at the base end in the same direction as the signal line 2 to be automatically coaxial shape with the cable C1, if the inside film 7 is taken off to make a twisted line.

The notch portion 33 for shield line and notch portion 43 for signal line are cut off from the edge of the side portion of each of the press-fitting pins 3 and 3 by width relatively larger than diameter of the twisted line of the shield line 1 and the signal line 2 that dipped the solder 8 in a large width part of the base end of the press-fitting pins 3 and 3 or by width to the extent of putting the shield line 1 and the signal line 2 having a variety of diameters.

As such, an order is described that a conducting line (hereinafter described as shield line and signal line) protruding from the connecting end of the cable C1 is fixed to the soldered portions 4, 14, and 24 in the press-fitting pin 3 provided in a cantilever shape serially with respect to the supporting frame 13 and the soldered portions 4, 14, and 24 are buried inside the synthetic resin mold body 5 so as to form the mold pin A for cable terminal.

First, the external film 6 of the shield line 1 protruding from the connecting end of the cable C1 is taken off to make a twisted line. Next, in the same manner, the internal film 7 of the signal line 2 is taken off to make a twisted line. The length of the twisted lines protruding from the cable C1 is all about 2 to 4 mm.

Taking-off and twisting jobs of the inner film 7 may be performed simultaneously. Since the shield line 1 should be avoided to be short from the signal line 2 due to such twisting, as shown in FIG. 2, or FIGS. 4A to 4C, the shield line 1 is automatically slightly tilted with respect to the extending axis of the cable C1 and the signal line 2 is of the same axis shape as the extending axis of the cable C1.

Subsequently, the solder 8 for the shield line 1 and the signal line 2 which are made of twisted lines is dipped so that the shield line 1 is soldered by putting it into the notch portion 33 for shield line from the cutting surface to constitute the soldered portion 14 of the shield line 1 and then signal line 2 is soldered by putting it into the notch portion 43 for signal line in the same manner to constitute the soldered portion 24 of the signal line 2.

The signal line 2 is provided at intervals as required with respect to the press-fitting pin 3 for shield line to which the press-fitting pin 3 is adjacent, if the soldered portion 14 of the shield line 1 is constituted, as it is automatically located just above the notch portion 43 for signal line or it is closely adjacent to a pin base end, thereby simply putting it into the notch portion 43 for signal line.

Thereafter, the soldered portions 14 and 24 of both sides are together buried inside the resin mold body 5 to constitute the mold pin A for cable terminal.

In the mold pin A for cable terminal according to the present embodiment, since the shield line 1 having a larger diameter than the signal line 2 is soldered so at to fill with the notch portion 33 to an appropriate thickness, which contributes to thin-filming of the soldered portion 14 and further to miniaturization of the mold body 5.

For example, in the present embodiment, the thickness of mold body of mold pin for cable terminal employing the one-core coaxial cable according to the related art is 2.45 mm, whereas the thickness of the mold body can be restricted to about 1 mm.

Further, although not shown, it would be good to regard a notch portion which is a partial constituent of the soldered portion for signal line, as an inserting hole.

The signal line 2, even if it is a twisted line, has a smaller diameter than the shield line 1. Hence, it is soldered in the state of inserting the signal line 2 made of a twisted line into the inserting hole or in the state of mounting the signal line 2 to the press-fitting pin 3 having an inserting hole to constitute a soldered portion. Further, it is possible to constitute a soldered portion by soldering the signal line in a press-fitting pin without the inserting hole or the notch portion.

Furthermore, the second to the seventh embodiments shown in FIGS. 5 to 10 are briefly described.

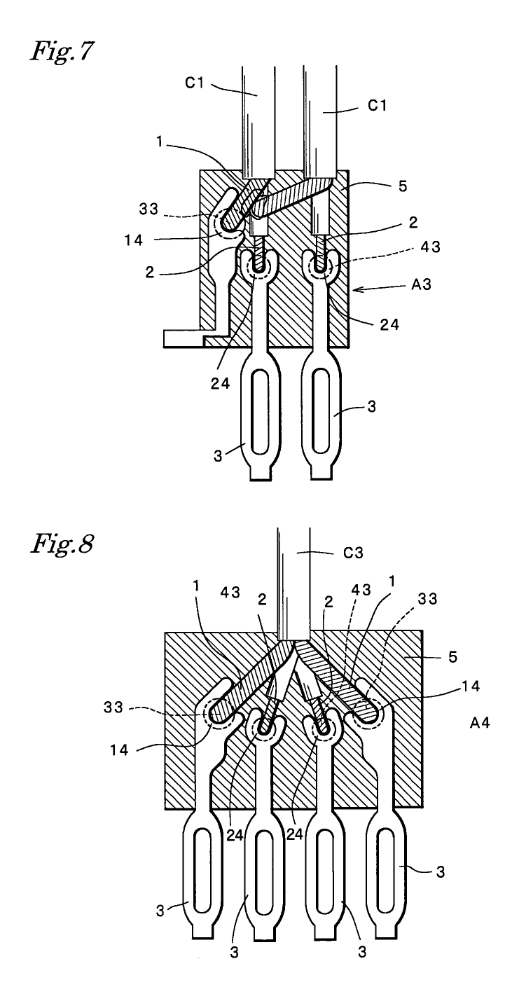

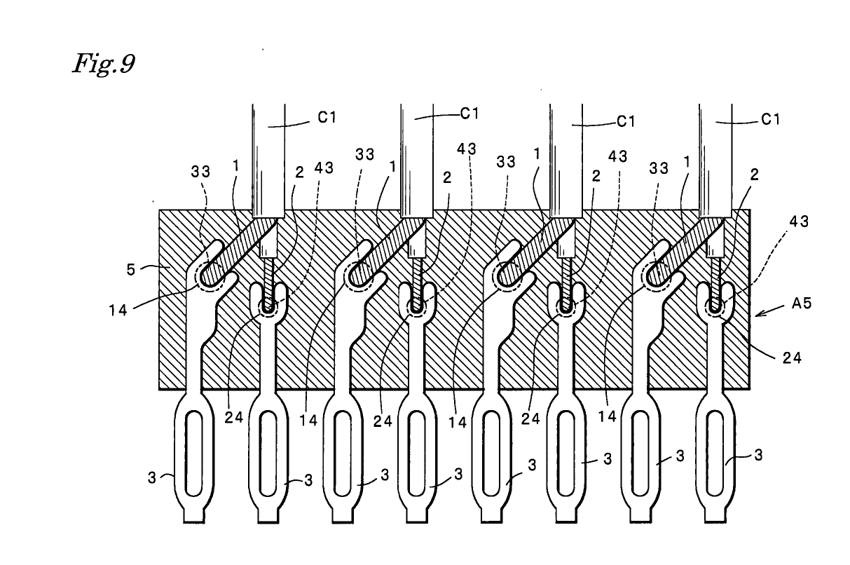

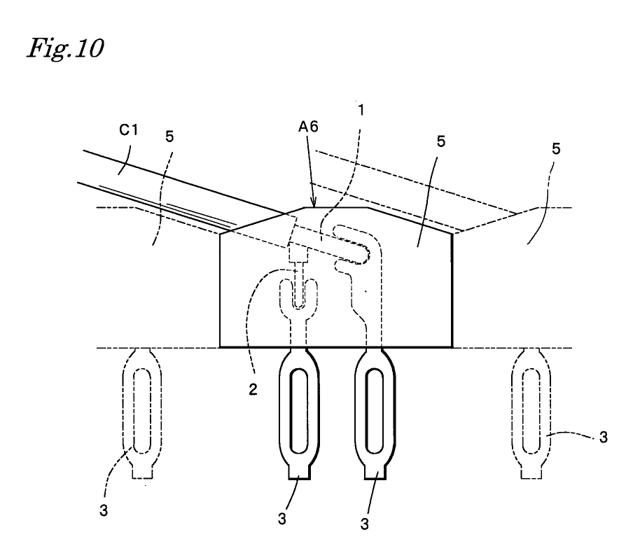

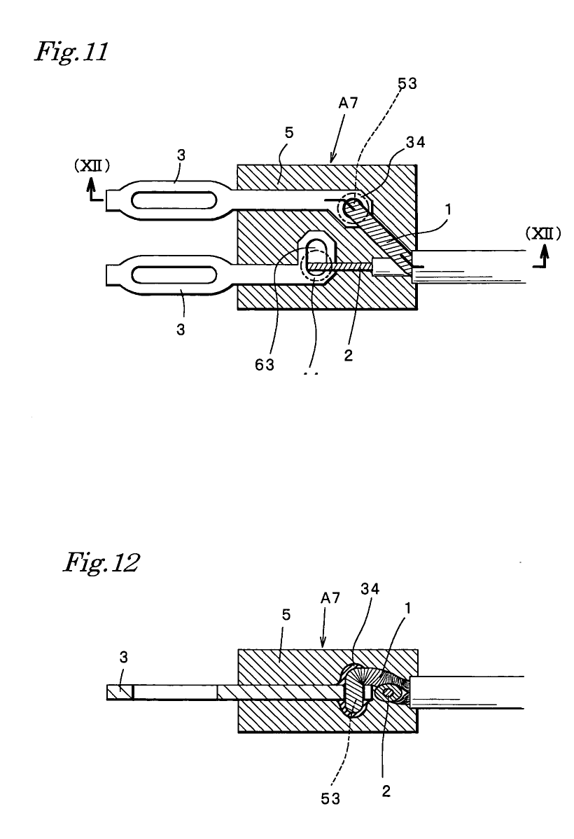

FIG. 5 (the second embodiment) illustrates a mold pin A1 for cable terminal that introduces the cable C1 into the mold body 5 from the side direction by employing a one-core coaxial cable C1, FIG. 6 (the third embodiment) illustrates a mold pin A2 for cable terminal employing a simple coated cable C2, FIG. 7 (the fourth embodiment) illustrates a mold pin A3 for cable terminal employing two one-core coaxial cables C1, FIG. 8 (the fifth embodiment) illustrates a mold pin A4 for cable terminal employing a two-core coaxial cable C3, FIG. 9 (the sixth embodiment) illustrates a mold pin A5 for cable terminal employing a plurality (four in the drawing) of a one-core coaxial cables C1, and FIG. 10 (the seventh embodiment) illustrates a high integration-typed mold pin A6 for cable terminal in a manner of being inserted into the one-core coaxial cable C1 from the inclined surface of the mold body 5 having two upper corners as an inclined surface.

Each of the embodiments makes no difference with the first embodiment in view of the fact that the shield line 1 and signal line 2 are inserted into the notch portion 33 for shield line and notch portion 43 for signal line, and the thickness range of the notch portions 33 and 43 with the shield line 1 and the signal line 2 to constitute each of the soldered portions 14 and 24.

Further, except for the third embodiment shown in FIG. 6, the notch portion 33 for the shield line is formed by being cut off from the edge portion in a slightly tilted manner in order to insert into the twisted shield line 1 slightly inclined with respect to the cable from the cutting surface in a straight line, which simplifies work of connecting and fixing the shield line 1.

Except for the fifth embodiment shown in FIG. 8, the notch portion 43 for signal line forms a notch in the same direction as the twisted signal line 2 protruding from the cable in a coaxial shape, which in the same manner simplifies work of connecting and fixing the signal line 2.

The fifth embodiment shown in FIG. 8 is a two-core coaxial cable C3 and thus forms the notch portion 43 for signal line in the same direction as a slow inclination of the signal lines 2 and 2.

Further, alternatively, the second to seventh embodiments might also constitute a soldered portion by soldering in the state of inserting the signal line into the inserting hole provided in the press-fitting pin or in the state of mounting the signal line to the press-fitting pin.

In the same manner as the conventional example, the mold pin for cable terminal according to the present invention can be employed so that a printed board or a printed board with IC bonded is disposed at an object portion to be measured and a through-hole for conduction, which is a contact of the printed board, a prober, and a handler are connected to conduct a performance test or control test or directly connect between ICs within the tester or connect to power supply of inside of an electronic apparatus.

The mold pin for cable terminal of the present invention as constituted above forms a soldered portion which inserts a conductive line of the cable connecting end into the base end of the press-fitting pin, the soldered portion forms a cutting surface at the edge to constitute a notch portion having the cutting surface as an opening end, and are soldered so that a conductive line of the cable connecting end is inserted into the notch portion and the notch portion fills with the conductive line to an appropriate thickness.

Hence, as compared with that like the press-fitting pin according to the related art, a conductive line is inserted into an inserting hole provided on the base end of a press-fitting pin to be soldered, cutting an unnecessary projection part of the soldering around the inserting hole makes it possible to reduce the soldered portion of the press-fitting pin and thickness of the mold body which is composed of a synthetic resin for burying the soldered portion. As a result, it is possible to miniaturize a mold pin of cable terminal itself and to integrate and mount a mold pin in the restricted range such as over the substrate, etc.

Further, since it is soldered by putting the shield line (twisted line) having a diameter larger than that of the signal line (twisted line) so as to fill the notch portion to an appropriate thickness, a reduction of the soldered portion and thickness of the mold body enables miniaturization of mold pin of cable terminal and further high-integration in the restricted scope.

Moreover, in the case where the notch portion of the soldered portion for fixing the shield line of cable notch-forms in the same direction as the twisted shield line, it can be set by mounting the shield line as in the natural state to the press-fitting pin, a complicated work of inserting the shield line into an inserting hole and cutting it as related art is not required, a shield setting work becomes very simple, thereby saving much trouble required for a cable fixing work as to the press-fitting pin conducted in one hundred to several hundreds units.

Further, since a soldered portion for fixing a signal line to a press-fitting pin forms a notch portion from the edge portion in the same direction as the twisted signal line, and is soldered in such a manner that a signal line is inserted into the notch portion and the notch portion fills with the signal line to an appropriate thickness, in the same manner as the shield line, it can be set by mounting the signal line comprising a twisted line as in the natural state to the press-fitting pin, an work of the signal line to connect and fix to the press-fitting pin becomes simple, thereby saving trouble and making optimum fixing structure.

Further, if the cable is a one-core coaxial cable or multi-core coaxial cable having more than two cores, a plurality of the press-fitting pins is provided parallel to each other at a supporting frame, which are spaced from each other so as to be separable from an end opposite to base end, the shield line and the signal line are inserted into the notch portion to be soldered in each of the press-fitting pin that is supported by the supporting frame, since the shield line and the signal line can be simply and certainly mount to each press-fitting pins in a stable state of being fixed by an oblique pattern in a supporting frame, and additionally the shield line and the signal line in the state of being inserted do not fall out by being occluded each other inside of each notch portion, resulting in a simultaneous soldering and much easier work of connecting and fixing the press-fitting pin.

Furthermore, as the constitution of the present invention is to insert the shield line or the signal line into the notch portion, differently from inserting it into an inserting hole as related art, restriction of the protrusion length of the shield line and signal line made of the twisted line to about 2 to 4 mm makes it possible to prevent change in an electric characteristic (impedance) of cable.

Having described specific embodiments of the invention with reference to the accompanying drawings, it will be appreciated that the present invention is not limited to those precise embodiments, and that various changes and modifications can be effected therein by one of ordinary skill in the art without departing from the scope of the invention as defined by the appended claims.

What is claimed is:

1. A mold pin for cable terminal comprising press-fitting pins press-fitted into through-holes for conduction,
wherein soldered portions for fixing conductive lines protruding from connecting ends of the cable are formed at base ends of the press-fitting pins, the soldered portions form notch portions at proper positions of edge portions and are formed in such a manner that the conductive lines of the connecting ends of the cable are inserted into the notch portions and the notch portions fills with the conductive lines to an appropriate thickness, and the soldered portions are buried inside the resin mold body.

2. The mold pin for cable terminal according to claim 1,
wherein the conductive lines buried inside the resin mold body are single signal lines or a signal line and a shield line, and at least the shield line is fixed to each of the press-fitting pins in the soldered portions.

3. The mold pin for cable terminal according to claim 2,
wherein in the notch portions of the soldered portions for fixing the shield line of cable, the edge portions thereof are cut out in the same direction as twisted shield lines.

4. The mold pin for cable terminal according to claim 3,
wherein the soldered portions for fixing the signal line of the cable to the press-fitting pins are soldered in such a manner that the edge portions thereof are cut out in the same direction as twisted signal lines, the signal line is inserted into the notch portion and the notch portions fills with the signal line to an appropriate thickness.

5. The mold pin for cable terminal according to claim 4, wherein the cable is a one-core coaxial cable or multi-core coaxial cable having more than two cores, a plurality of the press-fitting pins is provided parallel to each other being spaced from each other so as to be separable from an end opposite to the base end, the shield line and the signal line are inserted into the notch portion to be soldered in each of the press-fitting pins that is supported by the supporting frame.
